(19) United States
(12) Patent Application Publication
(10) Pub. No.: US 2007/0206312 A1
(43) Pub. Date: Sep. 6, 2007

(54) Hard disk protection system

(75) Inventors: Hao-Tai Hsieh, Taipei (TW); Kuo-Liang Tsai, Taipei (TW)

Correspondence Address: BIRCH STEWART KOLASCH & BIRCH, PO BOX 747, FALLS CHURCH, VA, 22040-0747, US

(73) Assignee: INVENTEC CORPORATION

(21) Appl. No.: 11/364,331

(22) Filed: Mar. 1, 2006

(51) Int. Cl. G11B 21/02; G11B 15/04

(52) U.S. Cl. 360/75; 360/60

(57) ABSTRACT

A hard disk protection system detects an X-axis travel, a Y-axis travel, and a Z-axis travel of a hard disk, and converts them into travel signals to calculate whether a threshold value is reached through the travel signals an algorithm. Reaching the threshold value indicates that the hard disk shakes heavily and the operation of the hard disk should be aborted. Then, a control module is required to send an interrupt signal informing a process module to abort reading the hard disk, so as to prevent the hard disk from being damaged due to the over-high shaking speed.

### BACKGROUND OF THE INVENTION

1. Field of Invention

The present invention relates to a protection system, and more particularly, to a hard disk protection system.

2. Related Art

With the fast development of the technology, notebook is widely accepted by people. For those busy with work, it is convenient to take along with a notebook to do work while on bus, train, mass rapid transit (MRT), and airplane. However, for example, when the user is on the bus, the head of the hard disk hits the tracks continuously due to the shake, causing the damage to the hard disk. Therefore, a protection mechanism is developed to prevent the hard disk from being easily damaged.

Referring to FIG. 1, it is the system architecture view of the prior art. At present, it is conventional to convert a three-dimensional analog signal into a digital signal firstly, and then transmit signals to inform a control chip to control the operation of the hard disk by a bus.

Firstly, a detector 110 detects the accelerated speed of the movement of the hard disk 150. The detected signal is an analog signal. Then, the analog signal from the detector 110 is converted into a digital signal by an analog-to-digital converter 120. After that, the converted digital signal is sent to a controller 130 to calculate and determine whether a threshold value is reached. The threshold value indicates the hard disk 150 is in a dangerous shaking state and should stop operating to avoid being damaged. The controller 130 will send an interrupt signal to the interrupter 140 for enabling it to stop the further operation of the hard disk 150 upon determining the operation of the hard disk 150 should be stopped.

However, in the prior art, the external analog-to-digital converter 120 is included for converting an analog signal into a digital signal for conducting the digital calculation. Provided that the received analog signal can be calculated directly, the speed to stop the operation of the hard disk will be enhanced.

### SUMMARY OF THE INVENTION

The object of the invention is to provide a hard disk protection system utilizing a three-dimensional analog signal for informing a controller directly to determine whether stopping the operation of the hard disk without the need of using an external analog-to-digital converter, so as to protect the hard disk from being damaged. Therefore, the problem in the prior art is resolved.

Therefore, for the above purpose, the invention provides a hard disk protection system for aborting reading of the hard disk by detecting the state of three-dimensional movement. The hard disk protection system comprises:

A detecting module is used for detecting the X-axis travel, the Y-axis travel, and the Z-axis travel of a hard disk, and obtaining the three-dimension travel when the hard disk is being shaken and moved.

A control module is used for calculating the X-axis travel, the Y-axis travel and the Z-axis travel by an algorithm to determine whether sending an interrupt signal, which sends an interrupt signal to the process module when the operation of the hard disk should be stopped to avoid being damaged upon obtaining whether the hard disk being in the level 1 shake state by calculating the three-axis travels.

A processing module is used for receiving the interrupt signal from the control module to interrupt the reading of the hard disk.

An external analog-to-digital converter is not required to convert a three-dimensional analog signal into a digital signal, and then send it to the control module. The control module can acquire the state of the hard disk only by calculating the analog signal transmitted thereto.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is the system architecture view of the prior art; and

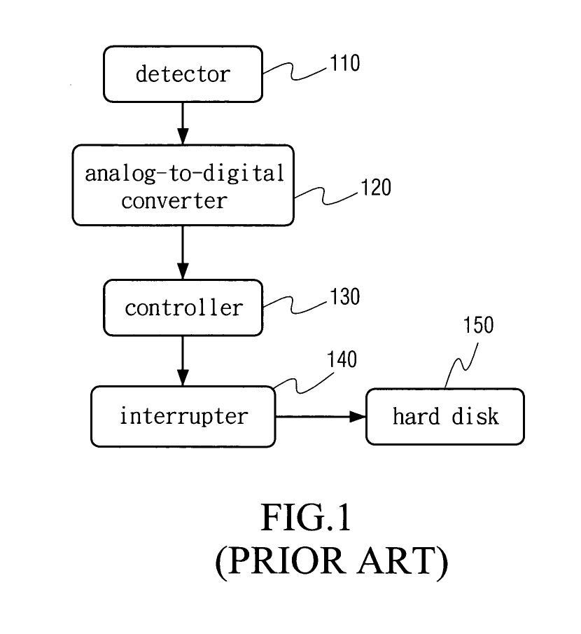

FIG. 2 is the architecture view of the hard disk protection system of the invention.

### DETAILED DESCRIPTION OF THE INVENTION

For further understanding the purpose, construction, features and the functions of the invention, the invention will be illustrated in accompany with the embodiment. The above illustration about the content of the invention and the following embodiments are used to demonstrate and explain the principles of the invention, and the appended claims.

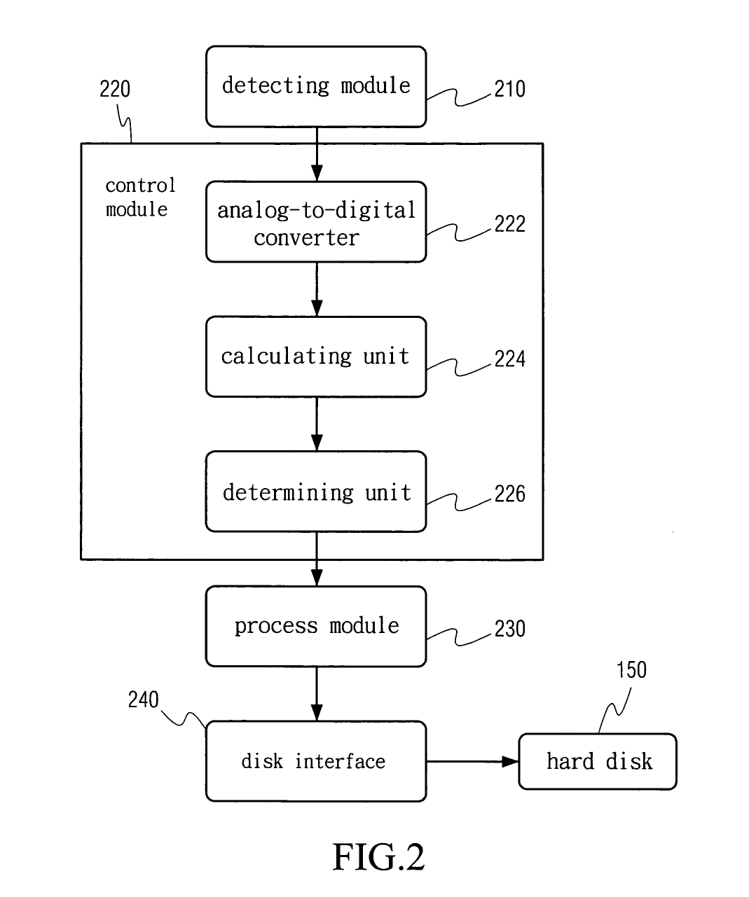

Referring to FIG. 2, it is the architecture view of the hard disk protection system of the present invention. The hard disk protection system detects the movement state of three-axis of a hard disk 150, and then determines whether to interrupt the reading of the hard disk 150 after calculating. The system comprises a detecting module 210, a control module 220, and a process module 230.

The detecting module 210 is used to detect the X-axis travel, the Y-axis travel, and the Z-axis travel of the hard disk 150. The unit of travels of the three axes is voltage. The detecting module 210 transmits the signals about the three axes in the form of analog signal to the control module 220.

The control module 220 receives the analog signals about the three axes sent by the detecting module 210, and then converts and calculates the analog signals through an algorithm for determining whether the shake value of the hard disk 150 has reached the threshold value. If the threshold value is reached, the interrupt signal will be sent.

The process module 230 is used to receive the interrupt signal sent by the control module 220 for interrupting the reading of the hard disk 150.

The control module 220 further comprises an analog-to-digital converter unit 222, a calculating unit 224 and a determining unit 226.

The analog-to-digital converter unit 222 is used to convert the X-axis travel, the Y-axis travel, and the Z-axis travel into digital signals.

The calculating unit 224 is connected to the analog-to-digital converter unit 222 for calculating the corresponding X-axis gravity value, Y-axis gravity value and Z-axis gravity value of the X-axis travel, the Y-axis travel and the Z-axis travel of digital signals, or calculate the corresponding accelerated speeds of the three axes, respectively.

The determining unit 226 is connected to the calculating unit 224 for determining whether a determining value resulted from calculating the X-axis gravity value, the Y-axis gravity value, and the Z-axis gravity value, reaches the threshold value of aborting the hard disk according to the algorithm, i.e., determining whether to abort the further operation of the hard disk according to the determining value calculated though the algorithm. When the determining value reaches the threshold value of interrupting the hard disk, an interrupt signal is sent to the process module 230. The threshold value of interrupting the hard disk is preset within the determining unit 226.

The system further comprises a disk interface 240 between the process module 230 and the hard disk 150, for transmitting the interrupt signal to inform the hard disk 150 to stop operating. The disk interface 240 is a Serial Advanced Technology Attachment (SATA) or a Parallel Advanced Technology Attachment (PATA).

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A hard disk protection system for detecting the three-dimensional travel state of a hard disk for interrupting the reading of the hard disk, comprising:
a detecting module for detecting a X-axis travel, a Y-axis travel, and a Z-axis travel of the hard disk, and then transform the X-axis, the Y-axis, and the Z-axis travels into travel signals;
a control module for calculating the X-axis travel, the Y-axis travel, and the Z-axis travel through the travel signals and an algorithm, to determine whether to send an interrupt signal;
a process module for receiving the interrupt signal sent by the control module to stop reading the hard disk.

2. The hard disk protection system according to claim 1, wherein the unit of the travel signals corresponding to the X-axis travel, the Y-axis travel, and the Z-axis travel is voltage.

3. The hard disk protection system according to claim 1, wherein the travel signals corresponding to the X-axis travel, the Y-axis travel, and the Z-axis travel are analog signals.

4. The hard disk protection system according to claim 2, wherein the control module further comprises an analog-to-digital converter unit for converting the analog signals corresponding to the X-axis travel, the Y-axis travel, and the Z-axis travel into digital signals.

5. The hard disk protection system according to claim 4, wherein the control module further comprises a calculating unit for calculating a corresponding X-axis gravity value, a corresponding Y-axis gravity value, and a corresponding Z-axis gravity value according to the digital signals corresponding to the X-axis travel, the Y-axis travel, and the Z-axis travel.

6. The hard disk protection system according to claim 5, wherein the control module further comprises a determining for determining whether a determining value has reached a threshold value to interrupt the hard disk, in which the determining value is resulted from calculating the X-axis gravity value, the Y-axis gravity value, and the Z-axis gravity value according to the algorithm, and when the determining value reaches the threshold value, the interrupt signals is sent to the process module.

7. The hard disk protection system according to claim 1, further comprising a disk interface between the process module and the hard disk for informing the hard disk to stop operation.

8. The hard disk protection system according to claim 7, wherein the disk interface is a Serial Advanced Technology Attachment (SATA).

9. The hard disk protection system according to claim 7, wherein the disk interface is a Parallel Advanced Technology Attachment (PATA).
